(19) United States
(12) Patent Application Publication
(10) Pub. No.: US 2025/0186873 A1
(43) Pub. Date: Jun. 12, 2025

(54) COLLABORATIVE EDUCATIONAL TOOL AND PROCESS

(71) Applicant: Owen Selden, Charleston, SC (US)

(72) Inventor: Owen Selden, Charleston, SC (US)

(21) Appl. No.: 18/532,474

(22) Filed: Dec. 7, 2023

(51) Int. Cl. A63F 3/04

(52) U.S. Cl. CPC A63F 3/0457; A63F 3/0478; A63F 2003/046; A63F 2003/0476

(57) ABSTRACT

A collaborative learning device and processes for groups to enable each person of the group to learn difficult subject matter by answering written questions, awarding points, revealing answers, and discussing answers and concepts. The device and process promotes technology, science, engineering and math courses, sometimes known as STEM disciplines, through collaborative learning centered on the devices of the invention. Devices of the collaborative game are a game board with markers and written questions associated with STEM subject indicators on the game board. Participants take turns selecting questions, answering individually, revealing and collaboratively discussing answers, and awarding points for correct answers. Participants award points to the most collaborative participant, which encourages participation and input from the participants.

### BACKGROUND OF THE INVENTION

The present invention provides devices and processes for collaborative learning, specifically devices and methods for groups to learn difficult subject matter through game-based interactions. Traditional pedagogical methods like lectures and individual studying often fail to provide full comprehension of complex topics. Collaborative and interactive learning fosters deeper engagement and allows students to discuss and debate concepts to gain complete understanding. There is a need for structured systems of collaborative learning that incentivize participation and create engaging environments for participants to learn from one another.

### SUMMARY OF THE INVENTION

The present invention is a collaborative learning device and processes for groups to enable each person of the group to learn difficult subject matter by answering written questions, awarding points, revealing answers, and discussing answers and concepts. The device and process promotes technology, science, engineering and math courses, sometimes known as STEM disciplines, through collaborative learning centered on the devices of the invention. Devices of the collaborative game are a game board with markers and written questions associated with STEM subject indicators on the game board. Participants take turns selecting questions, answering individually, revealing and collaboratively discussing answers, and awarding points for correct answers. Participants award points to the most collaborative participant, which encourages participation and input from the participants.

### BRIEF DRAWING DESCRIPTION

FIG. 1A is a portion of a schematic diagram of a game board for an embodiment of the invention.

FIG. 1B is a portion of the schematic diagram of a game board for an embodiment of the invention.

FIG. 1C is a portion of the schematic diagram of a game board for an embodiment of the invention.

FIG. 1D is a portion of the schematic diagram of a game board for an embodiment of the invention.

FIGS. 1A-1D together comprise an embodiment of a complete game board.

FIG. 2 is a depiction of a question and answer card according to an embodiment of the invention.

### DESCRIPTION OF PREFERRED EMBODIMENTS

One embodiment of the collaborative learning game and process comprises the steps of gathering participants into a group and selecting a participant to move a marker on a game board. The order of participation may be selected by each participant rolling dice or other random number generator. The selected participant then uses a die or other number generator to move a marker a number of STEM subject indicators on the board. The selected participant reveals a written question that is associated with the board STEM subject indicator. Each participant individually writes an answer to the question. The selected participant reveals their answer to the question. However, if the selected participant's answer is incorrect, another participant is identified (such as moving right to left among the group), until a participant with the correct answer is ascertained. The identified participant with the correct answer explains the answer. The remaining participants who have not answered reveal then their answer to the question. Participants who answered the question correctly are awarded points. Participants then discuss the question and answer to gain full comprehension of the correct answer to the question.

At one or more times during the game, participants award points to the most collaborative participant. Preferably, the participants award points to the most collaborative participant at the end of the game, although points may be awarded at other junctures, such as after each question. Awarding points to most collaborative participant encourages participation and sharing of knowledge of the subject.

In one embodiment, if none of the participants are able to correctly and/or fully understand and explain the answer, other resources are made available. For example, a professor or instructor could proctor the game, and help the participants to arrive at the correct answer. If the game is conducted virtually, such as with a virtual game board, or if a computer is available, the correct answer may be ascertained online using online resources, or AI.

A game board 2 comprises multiple STEM subject indicators 4. Progression is made through the multiple STEM subject indicators 8 in a game path or circuit of the game board. Question cards 6 are prepared beforehand that are associated with the STEM subject indicators on the board. Each STEM subject indicator covers an aspect or element of the subject matter to be learned. Questions associated with the subject indicators may become progressively more difficult, or build conceptual understanding, and a greater number of points may be awarded for correct answers to more difficult questions.

The process incorporates game elements like markers, scoring, turns, and competition to maintain engagement. Using written answers allows participants to initially formulate answers independently. Subsequently revealing answers and discussion of questions and answers ensures comprehension. Awarding points to collaborative participants incentivizes participation and teaching of others. Participants both learn from each other and build upon others' knowledge.

The process may be implemented in-person with a physical game board 2 or virtually using a shared virtual gameboard and game pieces or markers. Question cards may be presented on a screen that is shared or presented individually and/or remotely. Individual participant answers may be written on paper or input into a database.

The game is applicable to a wide range of educational topics and age groups. The collaborative and interactive nature results in high engagement, comprehension, and recall compared to standard teaching methods. The game fosters deeper engagement and comprehension, leverages collaboration and group discussion, and provides friendly competition. The game is structured, but allows flexibility.

In a specific embodiment, and by way of example, organic chemistry is the subject of the game. Organic chemistry is widely considered to be one of the most challenging undergraduate college courses. Students struggle with visualizing 3D molecular structures, understanding reaction mechanisms, and applying complex concepts. Current organic chemistry instruction tends to focus on memorizing facts rather than active understanding and learning.

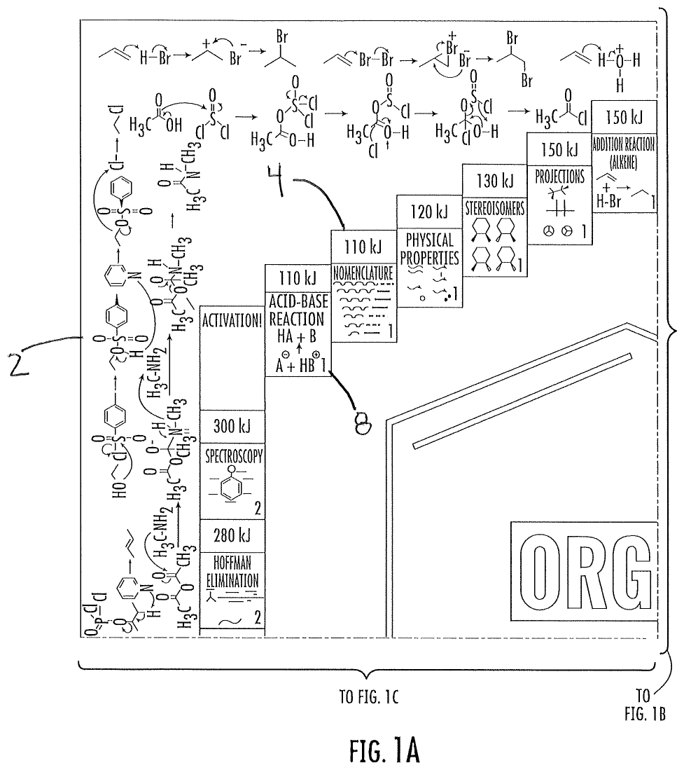

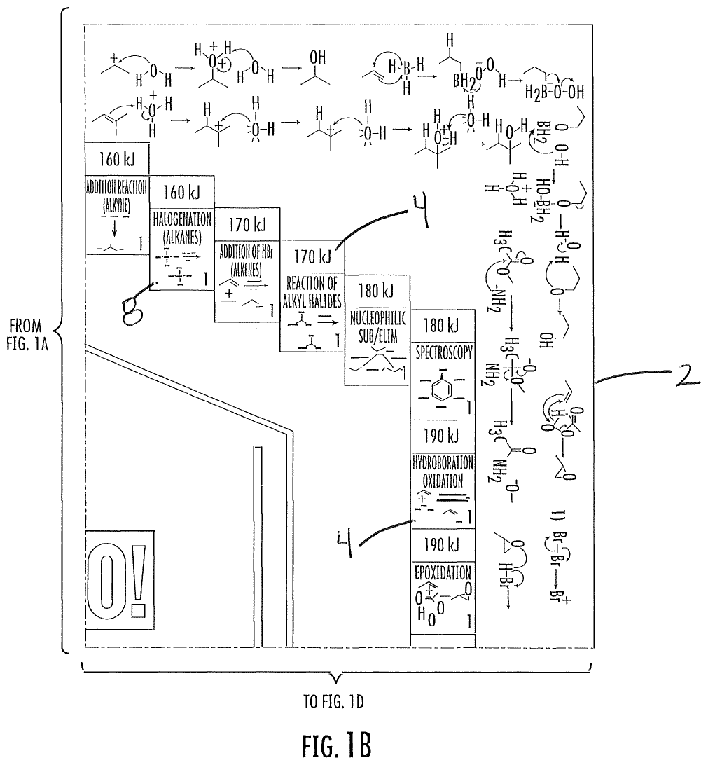

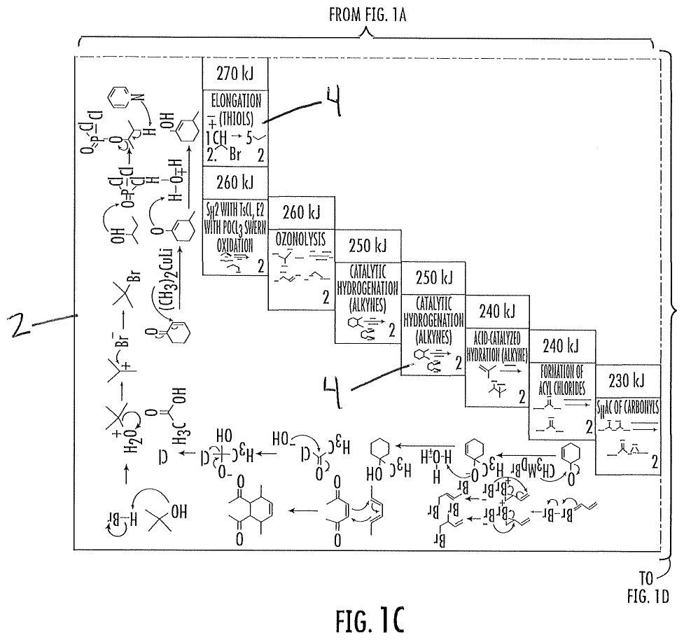

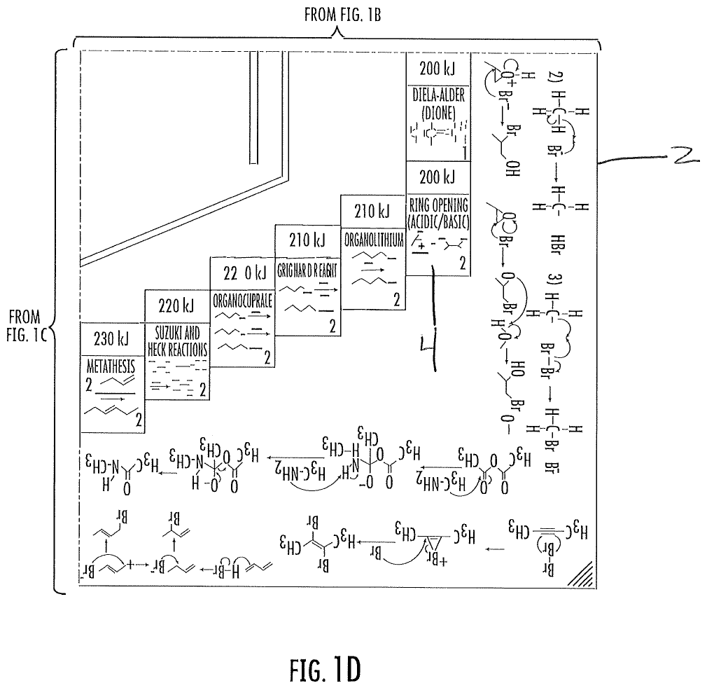

In this example, an educational board game facilitates peer learning of organic chemistry concepts through interactive gameplay. The game may comprise a hexagonal game board 2 with multiple STEM subject indicators 4 that may be indicated in multiple colors, with each color corresponding to a category of organic chemistry questions, and each STEM subject indicator corresponding to specific questions within the category. FIGS. 1A-1D. In one example, approximately 10 STEM subject indicators are allocated to each category identified by the STEM subject indicators. Categories for organic chemistry could include, for example: nomenclature, stereochemistry, reaction mechanisms, synthesis, spectroscopy, and functional groups.

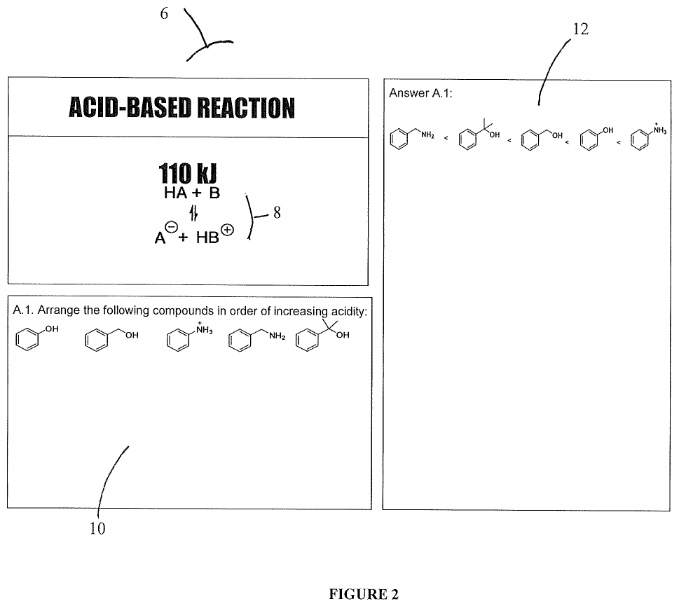

The game has a number of question cards 6 sufficient to cover the subject to be learned. FIG. 2. In the example, about 180 question cards with organic chemistry problems or questions covering major concepts may be used. The question cards are allocated so that some of the question cards are associated with and directed to each STEM subject indicator. Questions may have varying levels of difficulty. Participants are provided paper to provide a written answer to the question, or they input their answer into a database, such as by using a keyboard.

An example game card comprises: a graphic 8 corresponds to a graphic and subject that appears on the game board; a question 10 that pertains to the subject that appears on the game board that is to be answered by each participant; and an answer 12 to the question. The card is structured and arranged so that the graphic 8 and question 10 are visible to the participants, but the answer 12 is initially hidden from the participants. For example, the question card may be formed with the graphic and question on one side of card stock, and the answer on the opposite side. The question card is folded between the graphic side and the question side, with the answer is between the graphic side and the answer side so that the answer is not apparent without unfolding the card.

A random number or random selection device to select a first participant may be provided. The device could be, for example, dice, a spinner or a random number generator for numbers 1 to x, depending on the number of participants.

A score keeper is provided. The game board 2, as shown in FIGS. 1A-1D, awards points in imaginary joules, and the score keeper is designated as the Department of Energy. The score keeper may be a person, or the answers of participants may be machine graded and the score keeper is a machine, such as a computer.

To start the organic chemistry embodiment of the game, each player may design or be provided with a game piece or marker representing an atom, molecule, or chemistry concept. One player volunteers to act as the Department of Energy to track points. Players take turns actuating a random number generator, such as a die, and moving the marker around the board. When landing on a STEM subject indicator on the gameboard, the player draws a question card associated with the subject matter of the STEM subject indicator. Players have a time period, such as 3-5 minutes, to work through the question independently, with each player recording a written answer.

The first selected player reveals his or her answer. If the answer is correct, other players reveal their answers and players who with correct answers earn points (“energy”) based on the points associated with the question and the difficulty level. The group then collaborates by group discussion of the question and answer, and the reasons for the correct answer to the question. If no one answers correctly, outside resources may be consulted, such as a professor, the internet, or AI. The process is repeated, with another player moving a marker based on a randomly generated number. The game is continued until all players have the opportunity to lead the question and answer session, all questions have been presented and answered, or the game is mutually ended by the participants. The game can be adjusted based on available time to review a subset of questions.

The game board and question cards may be divided into a subset of a STEM subject matter, such as Chemistry I and Chemistry II, or Physics I and Physics II. Different colors may indicate the subsets. If a particular STEM subject matter indicator has not been addressed, or if the participants feel that mastery of the subject of one or more of the STEM subject indicators, then one or more question cards may be selected that are associated with the STEM subject indicators and answered by the participants until the subject area is mastered. In the example, Chemistry I may be mastered before moving to Chemistry II.

The goal is to end with the most “energy” points by answering questions and learning collaboratively. After gameplay, players vote to award bonus points to the most helpful participant. The player with the highest energy score wins. The engaging gameplay format promotes active learning and peer instruction of difficult STEM subject matter, such as organic chemistry.

In a particular embodiment, the game board 2 has STEM subject indicators 4 formed on the game board. The game board may be a physical game board, or it may be a virtual game board. Each STEM subject indicator has a symbol formed thereon. The symbol is preferred to be STEM related artwork indicia. The formula may be a mathematical equation, formula, electrical circuit, a calculation to be performed represented by symbols, physics, engineering, or mechanics. In the case of chemistry, the STEM related artwork indicia may represent a chemical reaction, chemical structure, spectroscopy properties, chemical reaction or synthesis. The difficulty of the material preferably increases as the players advance along the board. The board is preferred to have a starting point or “home”, advancing the marker along the STEM subject indicators 4 of the game board 2.

As a marker is located on the STEM subject indicator of the game board 2, multiple game cards 6 are associated with the particular STEM subject indicator 4. FIG. 2. One side of each game card has STEM related artwork indicia 8 appearing thereon that matches a STEM related artwork indicia 8 on the game board. One of the game cards that matches the STEM related artwork indicia on the board to where the marker has progressed is selected. An opposite side of the game card has a question that pertains to and is relevant to the STEM related artwork indicia. In the physical embodiment, the game card is folded so that the STEM related artwork indicia is on one side, and the answer is on the opposite side. The inside of the folded game card has the answer to the question. By the card being folded with the answer inside, the answer is not immediately revealed to the participant. FIG. 2 is shown in three pieces as a representation, but the card is formed in one sheet, and folded so that the STEM related artwork indicia and question are on opposite sides, and the answer or explanation is on the inside of the folded sheet. In a virtual version of the game, the STEM related artwork indicia and the answer are revealed, but the answer requires an additional demand of the system to reveal the answer.

In the particular embodiment of chemistry as shown in FIGS. 1A-1D, the game board 2 has a plurality of organic chemistry subject indicators 4, each with artwork indicia 8 that pertains to organic chemistry. The plurality of subject indicators are preferred to form a circuit. At least one game card 6 should be associated with each of the subject indicators on the game board having organic chemistry artwork indicia thereon. Multiple game cards, each having a different question and answer but the same artwork indicia, are preferred to be prepared for each subject indicator.

The game board 2 and game cards 6 may, for example, have STEM related artwork indicia 8 and questions 10 and answers 12 related to physics, calculus, linear algebra, circuits, statics, thermodynamics or other STEM subjects.

In a virtual embodiment, a processor creates a visual display on a screen. The visual display shows the game board and the game cards. The game cards are structured on the display so that the STEM related artwork indicia and question are initially displayed. Each game card is displayed in sequence as a virtual marker moves to a STEM subject indicator on the game board associated with the game card. The answer for the game card is withheld until the participants have each given an answer to the question and the question and answer are discussed among the participants. If the participants are physically in the same location, a single display may be used. If the participants are participating remotely, the processor may communicate the display to multiple remote monitors via the Internet.

Although the present invention has been described with reference to preferred embodiments and a subject area, variations and modifications exist within the scope and spirit of the invention.

What is claimed:

1. A collaborative game for learning science, technology, engineering, math (STEM) subject matter, comprising:
a game board comprising a plurality of STEM subject indicators associated with a STEM subject;
a plurality of question cards for each of the plurality of STEM subject indicators of the game board, each question card presenting a different question and answer to the question, the question cards comprising STEM subject indicators matching STEM subject indicators of the game board; and
STEM subject indicator markers constructed and arranged to move progressively along the plurality of STEM subject indicators formed on the game board.

2. A collaborative game for learning science, technology, engineering or math (STEM) subject matter as described in claim 1, wherein the game board comprises STEM related artwork indicia formed on each STEM subject indicator that is associated with the subject of the STEM subject indicator, and wherein the plurality of question cards for the subject of the STEM subject indicator of the game board comprises STEM related artwork that matches the STEM related artwork of the game board.

3. A collaborative game for learning science, technology, engineering or math (STEM) subject matter as described in claim 1, wherein the question cards are constructed and arranged so that the answer is separated from the question presented on the question card.

4. A collaborative game for learning science, technology, engineering or math (STEM) subject matter as described in claim 1, wherein the question cards are constructed and arranged so that the subject matter indicated on each question card is on an opposite side of the question presented by each question card, and the answer is positioned in an interior of the question card.

5. A collaborative game for learning science, technology, engineering or math (STEM) subject matter as described in claim 1, wherein the game board presents a first set of STEM subject indicators for a first level of a STEM course and a second set of STEM subject indicators a second level of the STEM course.

6. A collaborative game for learning science, technology, engineering or math (STEM) subject matter as described in claim 1, wherein the STEM subject matter presented on the STEM subject indicators of the game board and the associated question cards are mathematical representations.

7. A collaborative game for learning science, technology, engineering or math (STEM) subject matter as described in claim 1, wherein the STEM subject matter presented on the STEM subject indicators of the game board and the associated question cards are chemical representations.

8. A collaborative game for learning science, technology, engineering or math (STEM) subject matter as described in claim 1, wherein the STEM subject indicators form a circuit.

9. A collaborative learning process for learning STEM subject matter, comprising the steps of:
obtaining the collaborative game described in claim 1,
gathering a group of participants;
identifying a selected participant from the group of participants;
the selected participant advancing a STEM subject indicator marker of the plurality of STEM subject indicator on the game board to a first STEM subject indicator;
the selected participant revealing a written question on a game card of the plurality of game cards associated with the first STEM subject indicator to the group of participants;
participants of the group of participants individually providing a written answer to the question;
the selected participant revealing their written answer to the question;
participants who gave a correct answer to the question are given points;
the group of participants discuss the question and answer so that all participants of the group of participants understand the answer to the question;
each participant of the group of participants awarding points to their individually chosen participant of the group of participants deemed to be most collaborative during the game.

10. The collaborative learning process for learning STEM subject matter of claim 1, further comprising the steps of:
if the selected participant did not answer the question correctly, passing the question to another participant until a participant of the group of participants who wrote a correct answer is identified, and the participants of the group of participants that gave a correct written answer given points, and the correct answer is discussed by the group of participants;
selecting another participant from the group of participants;
another participant moving a STEM subject indicator marker to another position on the game board and revealing another written question associated with another position to the group of participants;
awarding points to participants of the group of participants who provide a correct written answer to another question;
the group of participants discussing the correct answer to another question.

11. The collaborative learning process for learning STEM subject matter of claim 1, further comprising the steps of continuing the collaborative learning process until a question card from each of the game board STEM subject indicators in a defined set of gameboard STEM subject indicators is selected and collaboratively answered.
